(19) United States
(12) Patent Application Publication
(10) Pub. No.: US 2023/0412034 A1
(43) Pub. Date: Dec. 21, 2023

(54) EXTERNAL ROTOR MOTOR AND HUB THEREOF

(71) Applicant: Delta Electronics, Inc., Taoyuan City (TW)

(72) Inventors: Chih-Yu Chien, Taoyuan City (TW); Chien-Ho Lee, Taoyuan City (TW); Yi-Ta Lu, Taoyuan City (TW)

(21) Appl. No.: 17/984,163

(22) Filed: Nov. 9, 2022

(30) Foreign Application Priority Data
Jun. 16, 2022 (CN) 202221511627.X

(51) Int. Cl. H02K 5/18; H02K 9/06; H02K 5/20

(52) U.S. Cl. CPC H02K 5/18; H02K 5/207; H02K 9/06

(57) ABSTRACT

The present disclosure provides an external rotor motor including a rotor, an air guider, a pillow and a stator. The rotor includes a hub. The air guider includes a connecting ring and rotor air-guiding members. The connecting ring is disposed on the hub. The rotor air-guiding members are disposed on the connecting ring. A first gap is formed among any two adjacent rotor air-guiding members and the connecting ring. The pillow includes a stator flange, a cylinder and fins. The stator flange is disposed on the cylinder. The fins are radially arranged on a first surface of the stator flange. A second gap is formed among any two adjacent fins and the stator flange. A first acute angle is formed between a radial extension direction of each of the fins and a first tangent direction of the cylinder. The stator is mounted on the pillow and rotates along an axis.

### CROSS-REFERENCE TO RELATED APPLICATION

This application claims priority to China Patent Application No. 202221511627.X filed on Jun. 16, 2022. The entire contents of the above-mentioned patent application are incorporated herein by reference for all purposes.

### FIELD OF THE INVENTION

The present disclosure relates to a motor, and more particularly to an external rotor motor having an air guider and fins and a hub thereof.

### BACKGROUND OF THE INVENTION

Generally, the conventional motor includes heat dissipating fins disposed around the periphery of the stator to enhance the heat dissipation. However, the heat dissipating fins of the conventional motor are configured as a radial structure extended outwardly from the axis, and the area of the periphery affects the heat dissipation efficiency.

In addition, the conventional motor includes an iron casing, a bushing for accommodating a shaft and a flange for connecting an impeller. The bushing and the flange are in connection to the iron casing by welding, respectively. However, it costs more to connect the above-mentioned components of the motor by welding.

Therefore, there is a need of providing a motor and a hub thereof to obviate the drawbacks encountered from the prior arts.

### SUMMARY OF THE INVENTION

It is an objective of the present disclosure to provide a motor, especially an external rotor motor, which achieves the advantages of improving the heat dissipation efficiency, reducing the rotor welding process and reducing the cost.

In accordance with an aspect of the present disclosure, there is provided an external rotor motor including a rotor, an air guider, a pillow and a stator. The rotor includes a hub and rotating along an axis. The air guider includes a connecting ring and a plurality of rotor air-guiding members. The connecting ring is annularly disposed on an outer periphery of the hub. The plurality of rotor air-guiding members are disposed on the connecting ring. A first gap is formed among any two adjacent rotor air-guiding members and the connecting ring. The pillow includes a stator flange, a cylinder and a plurality of fins. The stator flange is extended from the cylinder along a radial direction perpendicular to the axis, and includes a first surface. The plurality of fins are disposed on the first surface. The plurality of fins have a specific height in an axial direction parallel to the axis and are arranged along the radial direction. A second gap is formed among any two adjacent fins and the stator flange. A first acute angle is formed between a radial extension direction of the fin and a first tangent direction of the cylinder. The second gaps are spatially in communication with the first gaps. The stator is mounted on the pillow. The rotor is sleeved on the stator and rotates along the axis.

In accordance with another aspect of the present disclosure, there is provided a hub for a rotor of an external rotor motor including a top plate, a sidewall, a rotor flange and an hole flange. The sidewall is extended from a periphery of the top plate along an axial direction. A space is formed between the top plate and the sidewall. The rotor flange is connected to the sidewall, and extended along a radial direction perpendicular to the axial direction. The hole flange is extended from the top plate along the axial direction and is disposed in the space. The hole flange has an axis hole. The axis hole penetrates through the hole flange and the top plate. A shaft is disposed in the axis hole and tightly fitted to the hole flange. The top plate, the sidewall, the rotor flange and the hole flange are integrally formed into a weldless structure and made of a metal casting.

### BRIEF DESCRIPTION OF THE DRAWINGS

FIG. 1 is a schematic perspective view illustrating a motor according to an embodiment of the present disclosure;

FIG. 2 is a schematic exploded view illustrating the motor according to the embodiment of the present disclosure;

FIG. 3A is a schematic perspective view illustrating the hub of FIG. 1;

FIG. 3B is a schematic perspective view illustrating the hub according to another embodiment of the present disclosure;

FIG. 3C is a schematic perspective view illustrating the hub according to an additional embodiment of the present disclosure;

FIG. 3D is a cross-sectional view illustrating the hub of FIG. 3C;

FIG. 3E is a schematic perspective view illustrating the hub according to a further embodiment of the present disclosure;

FIG. 3F is a schematic perspective view illustrating the hub according to a variant embodiment of the present disclosure;

FIG. 4 is a schematic perspective view illustrating the connecting ring of FIG. 1;

FIG. 5 is a top view illustrating the connecting ring of FIG. 1;

FIG. 6 is a schematic perspective view illustrating the hub and the air guider according to a variant embodiment of the present disclosure;

FIG. 7 is a schematic perspective view illustrating the pillow and the stator of FIG. 1;

FIG. 8 is a top view illustrating the pillow of FIG. 1;

FIG. 9 is a cross-sectional view illustrating the hub of FIG. 1 along the section AA;

FIG. 10 is a schematic exploded view illustrating the air guider according to a variant embodiment of the present disclosure;

FIG. 11 is a schematic exploded view from another angle illustrating the air guider of FIG. 10; and

FIG. 12 is a cross-sectional view illustrating the air guider of FIG. 10 applied to a motor.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

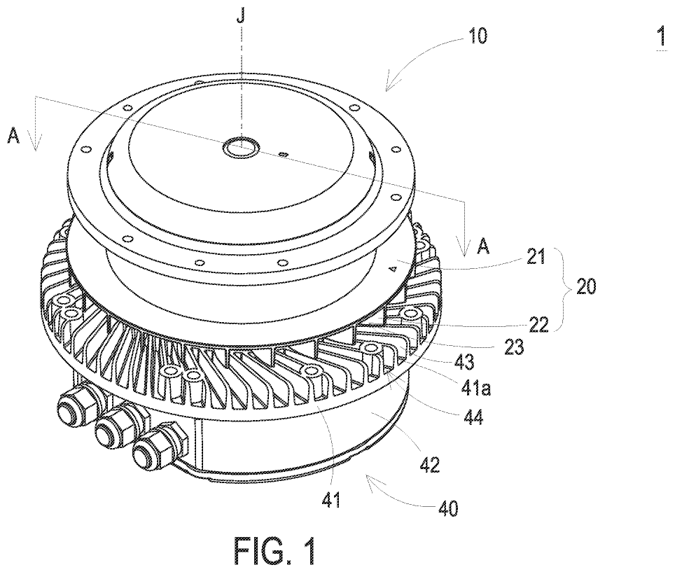

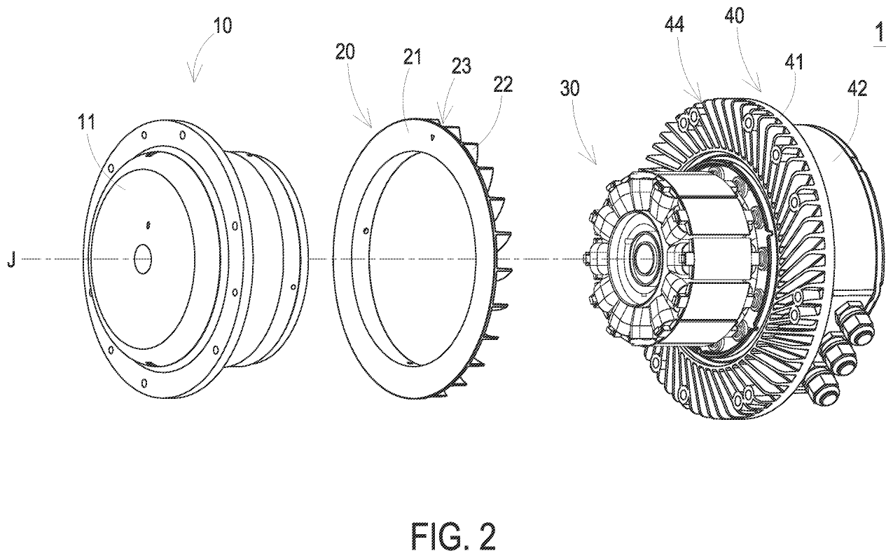

FIG. 1 is a schematic perspective view illustrating a motor according to an embodiment of the present disclosure, and FIG. 2 is a schematic exploded view illustrating the motor according to the embodiment of the present disclosure. As shown in FIG. 1 and FIG. 2, the external rotor motor 1 (motor 1 hereafter) includes a rotor 10, an air guider 20, a stator 30 and a pillow 40. The rotor 10 includes a hub 11. The air guider 20 is annularly disposed on an outer periphery of the rotor 10. The stator 30 is mounted on the pillow 40. The rotor 10 is sleeved on the stator 30 and rotates along the axis J.

Please refer to FIG. 2. The air guider 20 is a one piece ring structure including a connecting ring 21 and a plurality of rotor air-guiding members 22. The connecting ring 21 is annularly disposed on the outer periphery of the hub 11. The plurality of rotor air-guiding members 22 have a specific height in an axial direction parallel to the axis J, and are connected to the connecting ring 21 and substantially arranged along a radial direction (perpendicular to the axis J) with respect to the axis J. A first gap 23 is formed among any two adjacent rotor air-guiding members 22 and the connecting ring 21.

Please refer to FIG. 1 and FIG. 2. The pillow 40 includes a stator flange 41, a cylinder 42 and a plurality of fins 43. The stator flange 41 is disposed on a side of the cylinder 42 close to the rotor 10, and extended from the cylinder 42 outwardly with respect to the axis J in the radial direction perpendicular to the axis J. In other words, the plane where the stator flange 41 is located is orthogonal to the axis J. The stator flange 41 has a first surface 41a toward the rotor 10. The plurality of fins 43 are disposed on the first surface 41a. The plurality of fins 43 have a specific height in the axial direction and substantially arranged along the radial direction. In other words, the first surface 41a where the plurality of fins 43 are located is orthogonal to the axis J. The plurality of fins 43 are arranged radially with respect to the axis J. A second gap 44 is formed among any two adjacent fins 43, the stator flange 41 and the cylinder 42. The second gaps 44 are spatially in communication with the first gaps 23 of the air guider 20, so that airflows can pass through the first gap 23 and the second gap 44.

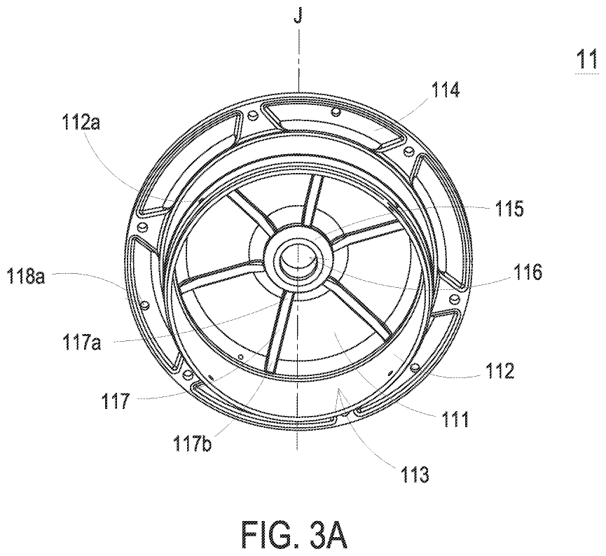

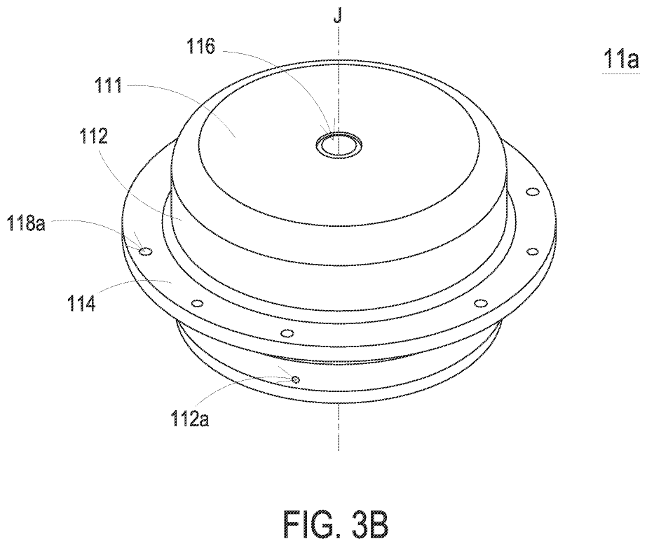

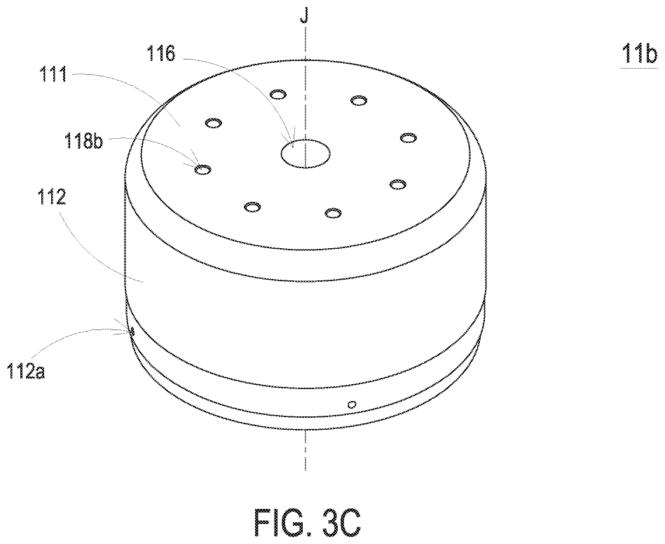

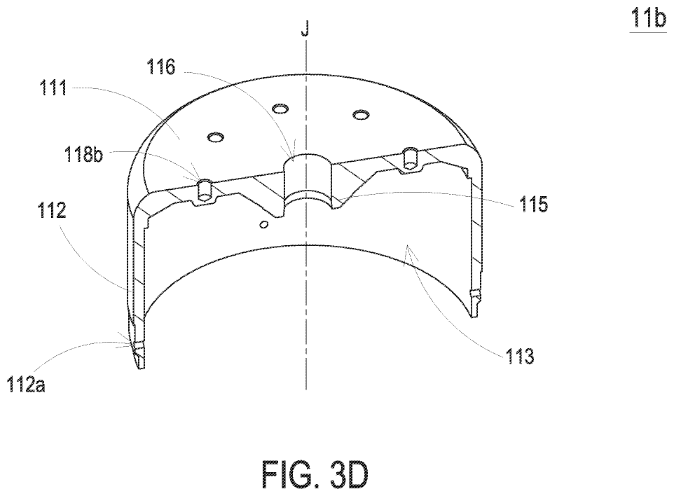

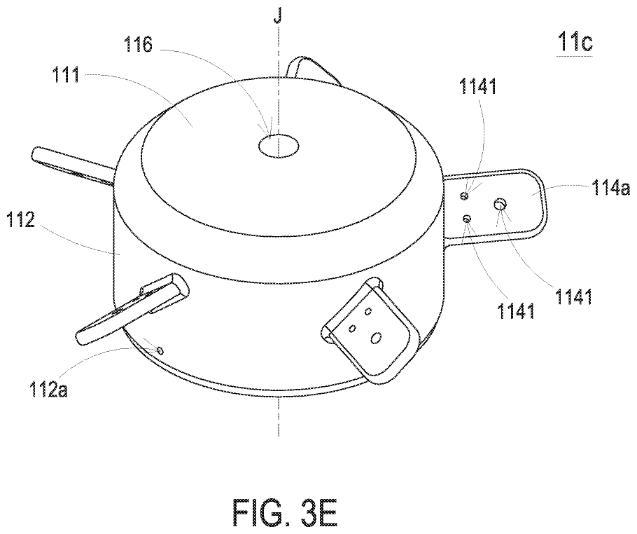

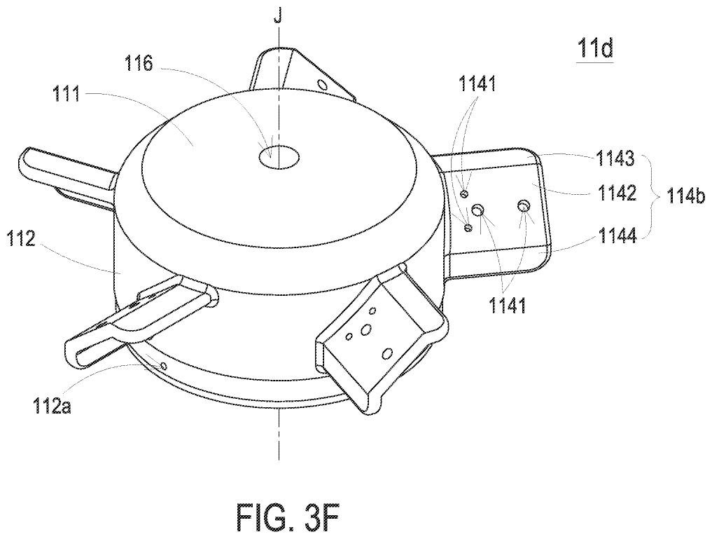

FIG. 3A is a schematic perspective view illustrating the hub of FIG. 1. As shown in FIG. 3A, the hub 11 of the present embodiment is integrally formed into one piece structure without welding, i.e. an integrally formed weldless structure. In other words, the top plate 111, the sidewall 112, the rotor flange 114, the hole flange 115 and the air-guiding ribs 117 of the hub 11 are integrally formed as a weldless structure made of a metal casting. The hub 11 includes the top plate 111 and the sidewall 112. The sidewall 112 is extended from the periphery of the top plate 111 along the axial direction, and a space 113 is formed between the top plate 111 and the sidewall 112. The thicknesses of the top plate 111 and the sidewall 112 are determined during one piece manufacturing process according to the requirements, and there is no need to adjust the thickness through other procedures.

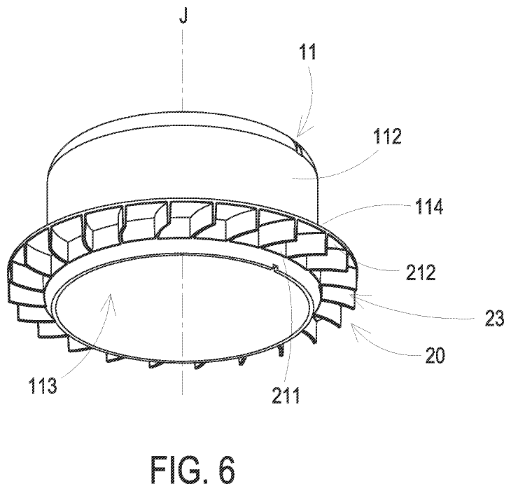

Please refer to FIG. 3A. In the present embodiment, the hub 11 includes at least one rotor flange 114. The rotor flange 114 is integrally formed on the hub 11 without welding. The rotor flange 114 is a complete annular structure without notches or grooves. The sidewall 112 has a specific height in the axial direction. The rotor flange 114 is disposed adjacent the top plate 111. The rotor flange 114 is configured to fix an impeller (not shown) thereon. In the present embodiment, the rotor flange 114 is for example but not limited to a centrifugal fan rotor flange. The rotor flange 114 is annularly disposed on and connected to the sidewall 112 of the hub 11 and extended along the radial direction. In an embodiment, the rotor flange 114 includes for example but not limited to a plurality of axial-flow fan rotor flanges (not shown) which are integrally formed on the hub 11 without welding, respectively. The rotor flange 114 can be arranged at any position of the hub 11 according to the required arrangement of the impeller (not shown). In an embodiment, the rotor flange 114 is disposed adjacent to the air guider 20, and the rotor flange 114 and the connecting ring 21 of the air guider 20 are integrally formed into one piece structure, as shown in FIG. 6. In other words, the impeller (not shown) is fixed to the one piece structure formed by the rotor flange 114 and the connecting ring 21 of the air guider 20.

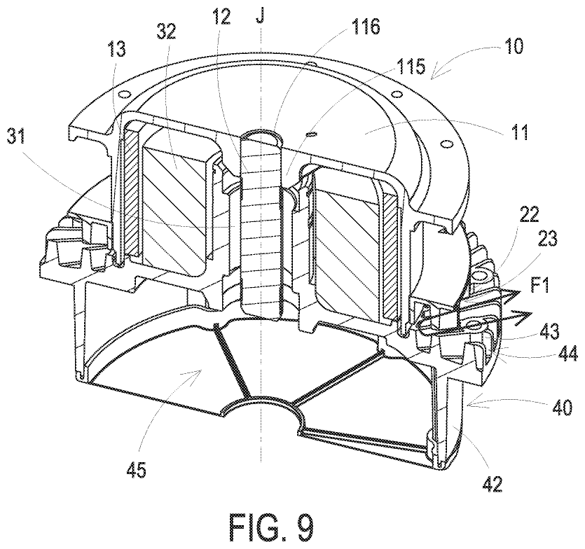

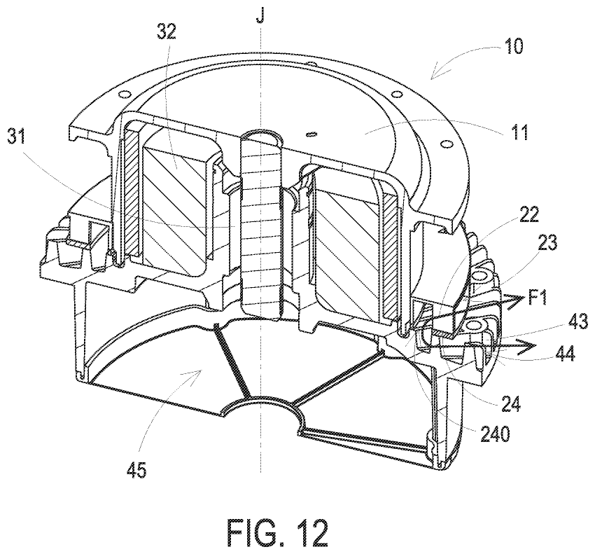

Please refer to FIG. 3A. In the present embodiment, the hub 11 includes the hole flange 115. The hole flange 115 is integrally formed on the hub 11 without welding. The hole flange 115 is extended from the top plate 111 along the axial direction to have a specific thickness, and is disposed in the space 113. The hole flange 115 has an axis hole 116. The axis hole 116 penetrates through the hole flange 115 and the top plate 111. The rotor 10 includes a shaft 12 (shown in FIG. 9). The shaft 12 is disposed in the axis hole 116 and tightly fitted to the hole flange 115. The thickness of the hole flange 115 can be adjusted according to actual requirements, and is not limited to the above-mentioned embodiment. In order to more clearly show the detailed structural features of the present disclosure, the shaft 12 is not shown in FIG. 1 to FIG. 3 and FIG. 7, but only shown in FIG. 9 and FIG. 12.

Please refer to FIG. 3A. The hub 11 of the present embodiment includes the plurality of air-guiding ribs 117. The plurality of air-guiding ribs 117 are integrally formed on the hub 11 without welding. The plurality of air-guiding ribs 17 are extended from the top plate 111 along the axial direction to have a specific thickness, and are disposed in the space 113 apart from each other, respectively. A first end 117a of each of the air-guiding ribs 117 is in connection to the hole flange 115, and a second end 117b of each of the air-guiding ribs 117 is disposed at the periphery of the top plate 111 and away from the hole flange 115. The thickness of the air-guiding ribs 117 can be adjusted according to actual requirements, and is not limited to the above-mentioned embodiment. When the rotor 10 rotates along the axis J, the plurality of air-guiding ribs 117 are driven to rotate, and the heat dissipation airflow is generated. In addition, the structural strength of the hub 11 is also enhanced by the arrangement of the plurality of air-guiding ribs 117.

Further, a fixing hole 112a can be disposed on a side of the sidewall 112 of the hub 11 away from the top plate 111 according to actual requirements. Moreover, a fixing hole 118a can be disposed on the rotor flange 114 to fix the impeller (not shown).

FIG. 3B is a schematic perspective view illustrating the hub according to another embodiment of the present disclosure. The position of the rotor flange 114 of the hub 11a shown in FIG. 3B is different from the hub 11 shown in FIG. 3A. As shown in FIG. 3B, the rotor flange 114 is disposed on the sidewall 112 apart from two opposite ends of the sidewall 112. In other words, the sidewall 112 is divided into two parts by the rotor flange 114 in the axial direction. As shown in FIG. 3B, a part of the sidewall 112 is disposed between the rotor flange 114 and the top plate 111.

FIG. 3C is a schematic perspective view illustrating the hub according to an additional embodiment of the present disclosure, and FIG. 3D is a cross-sectional view illustrating the hub of FIG. 3C. As shown in FIG. 3C and FIG. 3D, there is no rotor flange disposed on the sidewall 112 of the hub 11b. Moreover, a plurality of blind holes 118b are disposed on the top plate 111 to fix components. The hub 11b is an integrally formed metal casting. The thickness of the top plate 111 can be adjusted for disposing the blind holes 118b. The thickness of the top plate 111 can be adjusted to form the hole flange 115. When the shaft 12 is tightly fitted to the hole flange 115 through the axis hole 116, the structural strength of the hub 11b is maintained.

FIG. 3E is a schematic perspective view illustrating the hub according to a further embodiment of the present disclosure. There is no rotor flange disposed on the sidewall 112 of the hub 11c shown in FIG. 3E. A plurality of rotor installation elements 114a are disposed on the sidewall 112 of the hub 11c, and substantially extended along the radial direction with respect to the axis J. A plurality of fixing holes 1141 are disposed on the plurality of rotor installation elements 114a to install an axial-flow impeller (not shown), but not limited thereto. The rotor installation element 114a and the hub 11c are integrally formed into one piece structure using metal casting as the material. In the present embodiment, the hub 11c and the rotor installation element 114a are combined with each other without welding.

FIG. 3F is a schematic perspective view illustrating the hub according to a variant embodiment of the present disclosure. There is no rotor flange disposed on the sidewall 112 of the hub 11d shown in FIG. 3F. A plurality of rotor installation elements 114b are disposed on the sidewall 112 of the hub 11d and substantially extended along the radial direction with respect to the axis J. Different from the above-mentioned embodiment, the rotor installation element 114b shown in FIG. 3F is a one piece structure with two bandings, and is divided into a main body 1142, a first bending element 1143 and a second bending element 1144. The main body 1142, the first bending element 1143 and the second bending element 1144 are all in connection to the sidewall 112, so as to enhance the structural strength. A plurality of fixing holes 1141 are disposed on the main body 1142 to install an axial-flow impeller (not shown), but not limited thereto. In the present embodiment, the hub 11d and the rotor installation elements 114b are integrally formed into one piece structure using metal casting as the material, and thus are combined with each other without welding.

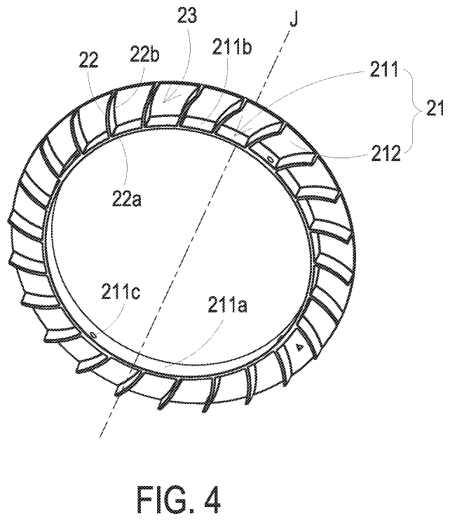

FIG. 4 is a schematic perspective view illustrating the connecting ring of FIG. 1. As shown in FIG. 4, the connecting ring 21 of the present embodiment includes a first part 211. The first part 211 has a first surface 211a, a second surface 211b and at least one fixing hole 211c. The first surface 211a and the second surface 211b are two opposite surfaces, wherein the first surface 211a is disposed toward the rotor 10. The first surface 211a attaches to the hub 11 of the rotor 10. A first side 22a of each of the rotor air-guiding members 22 is connected to the second surface 211b of the first part 211. The fixing hole 211c penetrates through the first surface 211a and the second surface 211b for fixing a fixing element (not shown) therethrough, so that the air guider 20 is fixed to the hub 11. The fixing element is for example but not limited to a screw.

Please refer to FIG. 4. The connecting ring 21 includes a second part 212. The second part 212 is extended from the periphery of a side of the first part 211 along the radial direction. The second part 212 is for example but not limited to perpendicularly connected to the first part 211. A second side 22b of each of the rotor air-guiding members 22 is in connection to the second part 212. Each of the rotor air-guiding members 22 is extended from the second part 211 and arranged radially with respect to the axis J. The first side 22a is adjacently in connection to the second side 22b. The first gap 23 is formed among any two adjacent rotor air-guiding members 22, the first part 211 and the second part 212.

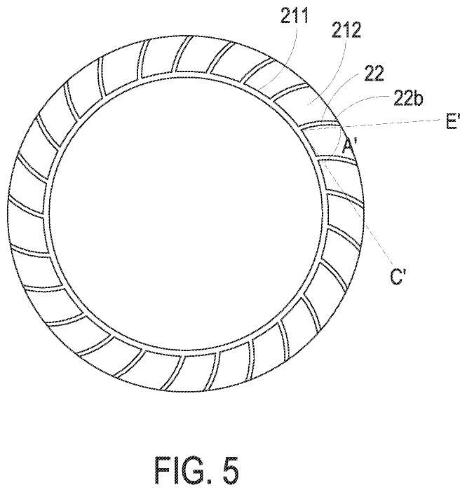

FIG. 5 is a bottom view illustrating the connecting ring of FIG. 1. The angle of vision of FIG. 5 is viewed along the axis J. In the present embodiment, the first part 211 and the second part 212 are complete annular structures without notches or grooves. The junction of the first part 211 and each of the rotor air-guiding members 22 has a second tangent direction C′, respectively. A second acute angle A′ is formed between a second extension direction E′ of each of the rotor air-guiding members 22 and the second tangent direction C′ of the first part 211. Therefore, the length of each of the rotor air-guiding member 22 is extended. In the present embodiment, the second side 22b of each of the rotor air-guiding members 22 is a curve. The second extension direction E′ of each of the rotor air-guiding members 22 is the extension direction of the straight line connecting the two ends of the second side 22b. In an embodiment, the second side 22b of each of the rotor air-guiding members 22 is a straight line, and the second extension direction E′ of the rotor air-guiding member 22 is the extension direction of the second side 22b, but not limited thereto. As shown in FIG. 5, limited by the annular width of the second part 212, the length of the rotor air-guiding member 22 can be increased by adjusting the angle and designing as a curve.

FIG. 6 is a schematic perspective view illustrating the hub and the air guider according to a variant embodiment of the present disclosure. As shown in FIG. 6, the hub 11 and the air guider 20 of a variant embodiment of the present disclosure are integrally formed into one piece structure without welding, for example but not limited to a metal casting. The hub 11 includes the sidewall 112 and the rotor flange 114. The rotor flange 114 is integrally formed on the hub 11 without welding. The rotor flange 114 is annularly disposed on and in connection to the sidewall 112 of the hub 11. The rotor flange 114 is disposed adjacent to the stator flange 41 and extended radially. The air guider 20 includes the connecting ring 21 and the rotor air-guiding member 22. The connecting ring 21 includes the first part 211 and the second part 212. The first part 211 and the sidewall 112 of the hub 11 are integrally formed into one piece structure without welding. The first part 211 has a specific height in the axial direction. The second part 212 and the rotor flange 114 of the hub 11 are integrally formed into one piece structure without welding. The second part 212 is extended from the periphery of a side of the first part 211 along the radial direction. The plurality of rotor air-guiding members 22 are integrally formed on the first part 211 and the second part 212 of the connecting ring 21. The first gap 23 is formed among any two adjacent rotor air-guiding members 22, the first part 211 and the second part 212. In other words, an impeller (not shown) of this embodiment is fixed on the one piece structure formed by the rotor flange 114 and the connecting ring 21.

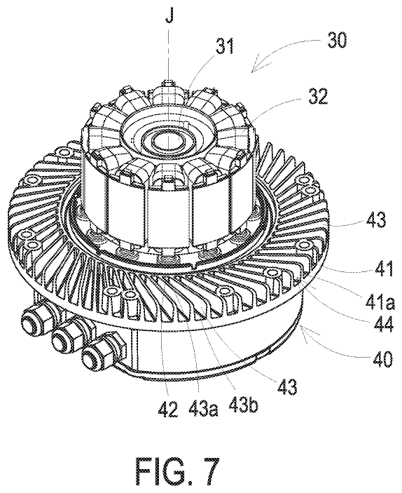

FIG. 7 is a schematic perspective view illustrating the pillow and the stator of FIG. 1. As shown in FIG. 7, the stator 30 includes a tube 31 and coils 32. The stator 30 is mounted on the pillow 40. The tube 31 is disposed along the axis J. The coils 32 are annularly disposed on the periphery of the tube 31. The stator flange 41 of the pillow 40 is disposed on the cylinder 42 and toward a side where the tube 31 is disposed. The first side 43a of each of the fins 43 of the pillow 40 is in connection to the cylinder 42. The second side 43b of each of the fins 43 is in connection to the first surface 41a of the stator flange 41. The first side 43a and the second side 43b are in connection to each other adjacently.

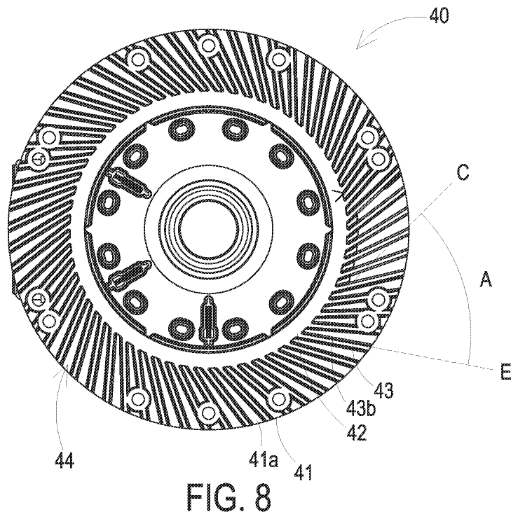

FIG. 8 is a top view illustrating the pillow of FIG. 1. As shown in FIG. 8, in the present embodiment, the stator flange 41 and the cylinder 42 are both complete annular structures. The junction of the cylinder 42 and each of the fins 43 has a first tangent direction C, respectively. A first acute angle A is formed between a first extension direction E of each of the fins 43 and the first tangent direction C of the cylinder 42. Therefore, the length of each of the fins 43 is extended, and the heat dissipating area is increased. In the present embodiment, the second side 43b of each of the fins 43 is a straight line, and the first extension direction E of each of the fins 43 is the extension direction of the second side 43b. In an embodiment, the second side 43b of each of the fins 43 is a curve. The first extension direction E of each of the fins 43 is the extension direction of the straight line connecting the two ends of the second side 43b, but not limited thereto.

FIG. 9 is a cross-sectional view illustrating the hub of FIG. 1 along the section AA. The rotor 10 includes the hub 11, the shaft 12 and magnet elements 13. The shaft 12 is disposed in the hub 11 and sleeved in the tube 31 of the stator 30. The shaft 12 is disposed in the axis hole 116 of the hub 11, and tightly fitted to the hole flange 115 of the hub 11. The magnet elements 13 are disposed on the inner periphery of the hub 11 and opposite to the coils 32 of the stator 30. A space 45 is formed in the interior of the cylinder 42 of the pillow 40, and the space 45 is configured to accommodate the electronic components (not shown) of the motor 1.

Please refer to FIG. 1 and FIG. 9. When the rotor 10 rotates along the axis J, the rotor air-guiding members 22 are driven by the rotor 30 to rotate, and a heat-dissipating flow F1 is generated. The heat-dissipating flow F1 flows into the second gap 44 between any two adjacent fins 43, passes through the first gap 23, and finally flows out through any two adjacent rotor air-guiding members 22. When the motor 1 rotates, the heat generated by the coils 32 can be transferred to the rotor air-guiding members 22 through the tube 31 and the hub 11, which are made of metal. Since the heat-dissipating flow F1 passes through the fins 43 and the rotor air-guiding members 22 which are made of metal, the heat dissipating effect is achieved. In an embodiment, the heat-dissipating flow F1 flows into the first gap 23 between any two rotor air-guiding members 22, passes through the second gap 44, and finally flows out through any two adjacent fins 43, but not limited thereto. The direction of the heat-dissipating flow F1 is not limited to the above-mentioned embodiments, and can be adjusted according to practical requirements.

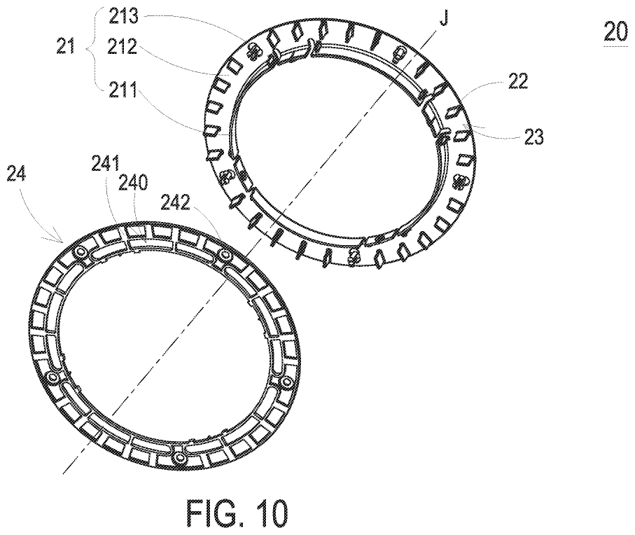

FIG. 10 is a schematic exploded view illustrating the air guider according to a variant embodiment of the present disclosure. As shown in FIG. 10, the air guider 20 of a variant embodiment of the present disclosure includes a reinforcing rim 24. The reinforcing rim 24 is annually disposed on the connecting ring 21, and has at least one air-guiding hole 240. The air-guiding hole 240 penetrates through the reinforcing rim 24. The reinforcing rim 24 has a first surface 241. The first surface 241 is on a side of the reinforcing rim 24 opposite the connecting ring 21, and toward the stator 30 (as shown in FIG. 12). The first surface 241 is an uneven surface, for example but not limited to include at least one of a protrusion, a recess and a curved surface or the combinations thereof, so that the advantage of reducing uneven flows is achieved.

In an embodiment, the at least one recess is recessed on an inner periphery of the reinforcing rim 24. By assembling the reinforcing rim 24 and the connecting ring 21, the air-guiding hole 240 is formed by the first part 211 of the connecting ring 21 and the recess of the reinforcing rim 24, collaboratively, but not limited thereto.

Please refer to FIG. 10. The plurality of rotor air-guiding members 22 are respectively extended from the second part 212 of the connecting ring 21 along the axial direction toward the reinforcing rim 24, and arranged as radial symmetry with respect to the axis J, but not limited thereto. The plurality of rotor air-guiding members 22 are disposed apart from the first part 211 of the connecting ring 21, but not limited thereto. In an embodiment, the arrangement of the plurality of rotor air-guiding members 22 can be non-radial symmetry, for example but not limited to the arrangement shown in FIG. 5. In an embodiment, the plurality of rotor air-guiding members 22 are extended from the reinforcing rim 24 along the axial direction toward the second part 212 of the connecting ring 21, but not limited thereto.

Please refer to FIG. 10. The connecting ring 21 includes a plurality of fasteners 213. The plurality of fasteners 213 are disposed on the second part 212 toward the reinforcing rim 24, respectively. The reinforcing rim 24 includes a plurality of position holes 242. The plurality of position holes 242 penetrate through the reinforcing rim 24, respectively, and are positionally corresponded to the corresponding one of the plurality of fasteners 213 of the connecting ring 21. By buckling the plurality of fasteners 213 of the connecting ring 21 in the corresponding one of the position holes 242 of the reinforcing rim 24, respectively, the reinforcing rim 24 is assembled with the connecting ring 21. In an embodiment, the connecting ring 21, the rotor air-guiding members 22 and the reinforcing rim 24 of the air guider 20 for example but not limited to be integrally formed into one piece structure without welding.

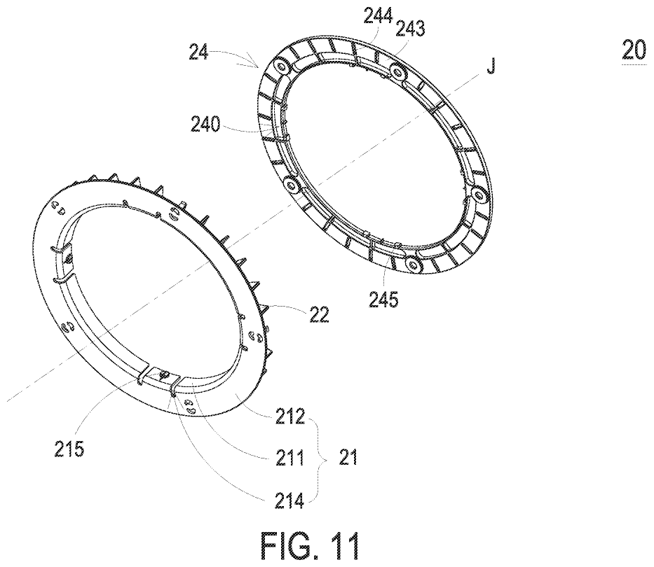

FIG. 11 is a schematic exploded view from another angle illustrating the air guider of FIG. 10. As shown in FIG. 11, the reinforcing rim 24 has a second surface 243. The second surface 243 is disposed toward the connecting ring 21. The reinforcing rim 24 includes a plurality of accommodation recesses 244. The plurality of accommodation recesses 244 are recessed on the second surface 243, and positionally corresponded to the plurality of rotor air-guiding members 22. Since the reinforcing rim 24 is assembled to the connecting ring 21, a free end of each of the rotor air-guiding members 22 is accommodated in the corresponding one of the accommodation recesses 244, and the advantages of positioning and enhancing the structural strength are achieved.

As shown in FIG. 11, the connecting ring 21 includes a plurality of position recesses 214. The plurality of position recesses 214 are recessed from a free end of the first part 211 toward the second part 212, respectively. The reinforcing rim 24 includes a plurality of protrusions 245. The plurality of protrusions 245 are extended from an inner periphery of the reinforcing rim 24 toward the axis J. Each of the protrusions 245 of the reinforcing rim 24 is accommodated in the corresponding one of the position recesses 214 of the connecting ring 21, so that the reinforcing rim 24 is assembled with and positioned on the connecting ring 21. The connecting ring 21 includes a plurality of protrusions 215. Each of the protrusions 215 is disposed between two position recesses 214 adjacent to each other. The plurality of protrusions 215 are radially extended from the inner surface of first part 211 toward the axis J. The plurality of protrusions 215 are configured for assembling the connecting ring 21 to the sidewall 112 of the hub 11. The sidewall 112 further includes a plurality of recesses for accommodating the protrusions 215. Each of the recesses of the sidewall 112 are disposed within the corresponding one of the protrusions 215, so that the connecting ring 21 is assembled to the sidewall 112 of the hub 11. In another embodiment, the connecting ring 21 includes a plurality of recesses (not shown). The sidewall 112 has a plurality of protrusions (not shown). Each of the protrusions of the sidewall 112 are disposed within the corresponding one of the recesses of the connecting ring 21, so that the connecting ring 21 is assembled to the sidewall 112 of the hub 11. The plurality of recesses could be formed as a groove for accommodating the protrusions 215.

FIG. 12 is a cross-sectional view illustrating the air guider of FIG. 10 applied to a motor. As shown in FIG. 12, the reinforcing rim 24 is disposed between the plurality of rotor air-guiding members 22 and the plurality of fins 43. The inner periphery of the reinforcing rim 24 is in connection to the first part 211 of the connecting ring 21. When the rotor 10 rotates along the axis J, the air-guiding members 22 are driven by the rotor 30 to rotate, and a heat-dissipating flow F1 is generated. The heat-dissipating flow F1 flows into the second gap 44 between any two adjacent fins 43, then flows in the first gap 23 through the air-guiding hole 240 of the reinforcing rim 24, and finally flows out through any two adjacent rotor air-guiding members 22. The reinforcing rim 24 is configured to guide airflows, so that the advantage of enhancing the heat dissipation is achieved.

From the above descriptions, the present disclosure provides an external rotor motor. By the structural features of the rotor air-guiding members of the air guider and the fins of the pillow, when the rotor rotates, a heat-dissipating flow is generated for heat dissipation. In addition, an acute angle is formed between the extension direction of each of the rotor air-guiding members and the tangent direction of the first part of the connecting ring, and an acute angle is formed between the extension direction of each of the fins and the tangent direction of the cylinder, so that the lengths of the rotor air-guiding members and the fins are extended, and the heat dissipating area is increased. Moreover, the rotor is integrally formed into one piece structure without welding, so as to reduce the risk of failure and reduce the cost. Furthermore, since the reinforcing rim of the present disclosure guides airflows, the advantage of enhancing the heat dissipation is achieved.

While the disclosure has been described in terms of what is presently considered to be the most practical and preferred embodiments, it is to be understood that the disclosure needs not be limited to the disclosed embodiment.

What is claimed is:

1. An external rotor motor comprising:
a rotor comprising a hub and rotating along an axis;
an air guider comprising a connecting ring and a plurality of rotor air-guiding members, wherein the connecting ring is annularly disposed on an outer periphery of the hub, the plurality of rotor air-guiding members are disposed on the connecting ring, and a first gap is formed among any two adjacent rotor air-guiding members and the connecting ring;
a pillow comprising a stator flange, a cylinder and a plurality of fins, wherein the stator flange is extended from the cylinder along a radial direction perpendicular to the axis, and has a first surface, wherein the plurality of fins are disposed on the first surface, and the plurality of fins have a specific height in an axial direction parallel to the axis, and are arranged along the radial direction, wherein a second gap is formed among any two adjacent fins and the stator flange, wherein a first acute angle is formed between a radial extension direction of the fin and a first tangent direction of the cylinder, wherein the second gaps are spatially in communication with the first gaps; and
a stator mounted on the pillow, wherein the rotor is sleeved on the stator and rotates along the axis.

2. The external rotor motor according to claim 1, wherein the hub of the rotor is an integrally formed weldless structure, and comprises a top plate and a sidewall, wherein the sidewall is extended from a periphery of the top plate along the axial direction, and a space is formed between the top plate and the sidewall.

3. The external rotor motor according to claim 2, wherein the hub comprises a rotor flange for fixing an impeller, wherein the rotor flange is annularly disposed on the sidewall and extended along the radial direction, wherein the impeller is a centrifugal impeller or an axial-flow impeller.

4. The external rotor motor according to claim 3, wherein the rotor flange and the air guider are integrally formed into one piece structure.

5. The external rotor motor according to claim 2, wherein the hub comprises a hole flange, wherein the hole flange is extended from the top plate along the axial direction and disposed in the space, wherein the hole flange has an axis hole, and the axis hole penetrates through the hole flange and the top plate, wherein the rotor comprises a shaft, the shaft is disposed in the axis hole and tightly fitted to the hole flange.

6. The external rotor motor according to claim 5, wherein the hub comprises a plurality of air-guiding ribs, the plurality of air-guiding ribs are extended from the top plate along the axial direction and are disposed in the space, respectively, wherein a first end of each of the air-guiding ribs is in connection with the hole flange, and a second end of each of the air-guiding ribs is disposed away from the hole flange.

7. The external rotor motor according to claim 1, wherein the connecting ring comprises a first part, the first part has a first surface, a second surface and a fixing hole, and the first surface attaches the hub, wherein a first side of the rotor air-guiding member is connected to the second surface of the first part, wherein the fixing hole penetrates through the first surface and the second surface for fixing a fixing element in the fixing hole, so that the air guider is fixed to the hub.

8. The external rotor motor according to claim 7, wherein the connecting ring comprises a second part, wherein the second part is extended from a periphery of the first part along the radial direction, wherein a second side of the rotor air-guiding member is in connection to the second part, and the rotor air-guiding member is extended from the second part along the axial direction, wherein the first side is adjacently in connection to the second side.

9. The external rotor motor according to claim 8, wherein the second side of the rotor air-guiding member is a curve, and a second acute angle is formed between a straight line connecting two ends of the second side and a second tangent direction of the second part.

10. The external rotor motor according to claim 1, wherein a first side of the fin is in connection to the cylinder, a second side of the fin is in connection to a first surface of the stator flange, wherein the first side is adjacently in connection to the second side.

11. The external rotor motor according to claim 10, wherein the second side is a curve, and a first acute angle is formed between a straight line connecting two ends of the second side and a first tangent direction of the second part.

12. The external rotor motor according to claim 8, wherein the air guider comprises a reinforcing rim, and the reinforcing rim is annularly disposed on the connecting ring, wherein the reinforcing rim has a first surface, the first surface is on a side of the reinforcing rim opposite the connecting ring, and toward the stator, wherein the first surface is an uneven surface.

13. The external rotor motor according to claim 12, wherein the reinforcing rim has an air-guiding hole penetrating through the reinforcing rim.

14. The external rotor motor according to claim 12, wherein the plurality of rotor air-guiding members are respectively extended from the second part of the connecting ring along the axial direction toward the reinforcing rim, and arranged as radial symmetry with respect to the axis, wherein the plurality of rotor air-guiding members are disposed apart from the first part of the connecting ring.

15. The external rotor motor according to claim 12, wherein the connecting ring comprises a plurality of fasteners, wherein the plurality of fasteners are disposed on the second part toward the reinforcing rim, respectively, wherein the reinforcing rim comprises a plurality of fixing holes, wherein the plurality of fixing holes penetrate the reinforcing rim and positionally correspond to the plurality of fasteners, respectively, so that the plurality of fasteners are buckled to the corresponding fixing holes, respectively.

16. The external rotor motor according to claim 12, wherein the reinforcing rim has a second surface disposed toward the connecting ring, wherein the reinforcing rim comprises a plurality of accommodation recesses, wherein the plurality of accommodation recesses are recessed on the second surface and positionally corresponded to the plurality of rotor air-guiding members, respectively, wherein a free end of each of the rotor air-guiding members is accommodated in the corresponding one of the accommodation recesses.

17. The external rotor motor according to claim 12, wherein the connecting ring comprises a plurality of position recesses, wherein the plurality of position recesses are recessed from a free end of the first part toward the second part, wherein the reinforcing rim comprises a plurality of protrusions, the plurality of protrusions are extended from an inner periphery of the reinforcing rim toward the axis, wherein each of the protrusions of the reinforcing rim is accommodated in the corresponding one of the position recesses of the connecting ring.

18. A hub for a rotor of an external rotor motor comprising:
a top plate;
a sidewall extended from a periphery of the top plate along an axial direction, and a space is formed between the top plate and the sidewall;
a rotor flange connected to the sidewall, and extended along a radial direction perpendicular to the axial direction; and
a hole flange extended from the top plate along the axial direction and disposed in the space, wherein the hole flange has an hole, and the hole penetrates through the hole flange and the top plate, wherein a shaft is disposed in the hole and tightly fitted to the hole flange,
wherein the top plate, the sidewall, the rotor flange and the hole flange are integrally formed into a weldless structure and made of a metal casting.

19. The hub according to claim 18, wherein the rotor flange and an air guider are integrally formed into one piece structure, wherein the air guider comprises a connecting ring and a plurality of rotor air-guiding members, wherein the connecting ring is annularly disposed on an outer periphery of the hub, and the plurality of rotor air-guiding members are disposed on the connecting ring.

20. The hub according to claim 18, wherein the sidewall comprises a plurality of rotor installation elements substantially extended along the radial direction, wherein the plurality of rotor installation elements and the hub are combined with each other without welding.
